(19) United States
(12) Patent Application Publication
(10) Pub. No.: US 2011/0087739 A1
(43) Pub. Date: Apr. 14, 2011

(54) Routing User Data Entries to Applications

(75) Inventors: Hsuan-Yu Jerry Lin, Seattle, WA (US); David T. Pan, Seattle, WA (US)

(73) Assignee: Microsoft Corporation, Redmond, WA (US)

(21) Appl. No.: 12/577,400

(22) Filed: Oct. 12, 2009

(51) Int. Cl. G06F 15/16; G06F 17/30; G06F 3/00

(52) U.S. Cl. 709/206; 715/748; 707/E17.001

(57) ABSTRACT

A user data entry is received at a mobile communications device. After receiving the user data entry, user selections of a first application and a second application are received. In response to the user selections, the user data entry is routed to both the first application and the second application. Additionally, a list of user data entries can be maintained and displayed, allowing the user to select user data entries from the list and also select an application to which a selected user data entry is to be routed.

### BACKGROUND

As technology has advanced the functionality provided by computing devices has increased. Users oftentimes have computing devices that run multiple different applications into which they can input data. This increased functionality, however, is not without its problems. One such problem is that it is oftentimes a cumbersome process for the user to locate and run the particular application into which they want to input data, and/or to transfer the data from one application to another. Another problem is that needing to locate and run the particular application into which they want to input data and/or transfer data from can slow the user down. These problems can result in the user becoming frustrated and/or dissatisfied with the device.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, a user data entry is received at a mobile communications device. After receiving the user data entry, user selections of a first application and a second application are received. In response to the user selections, the user data entry is routed to both the first application and the second application.

In accordance with one or more aspects, a user interface module displays a data input bar. An input module receives both a first user data entry and a second user data entry into the data input bar, and also receives a user selection of an application to which the first user data entry is to be routed. A generic input bar module receives both the first user data entry and the second user data entry and maintains a list of user data entries including both the first user data entry and the second user data entry The generic input bar module also provides the list to the user interface module for display, receives the user selection of the first user data entry from the displayed list of user data entries, and routes the first user data entry to the application in response to the user selection of the first data entry from the displayed list of user data entries and to the user selection of the application.

### BRIEF DESCRIPTION OF THE DRAWINGS

The same numbers are used throughout the drawings to reference like features.

FIG. 1 illustrates an example system implementing the routing user data entries to applications in accordance with one or more embodiments.

FIG. 2 is a diagram illustrating an example screen display of a mobile communications device in accordance with one or more embodiments.

FIG. 3 is a diagram illustrating another example screen display of a mobile communications device in accordance with one or more embodiments.

FIG. 4 is a flowchart illustrating an example process for a device routing user data entries to applications in accordance with one or more embodiments.

FIG. 5 is a flowchart illustrating another example process for a device routing user data entries to applications in accordance with one or more embodiments.

FIG. 6 illustrates an example computing device that can be configured to implement the routing user data entries to applications in accordance with one or more embodiments.

### DETAILED DESCRIPTION

Routing user data entries to applications is discussed herein. A generic data input bar is presented by a mobile communications device, allowing a user of the device to input text, photo, or other data without first identifying an application to which the text, photo, or other data is to be routed. After entering the text, photo, or other data, the user can select one or more applications to which that data is to be routed. The applications can include applications running on the mobile communications device and/or applications running at a remote service. Additionally, a list of multiple data inputs can be maintained, and the user can select a previously entered data input from the list for routing to one or more applications.

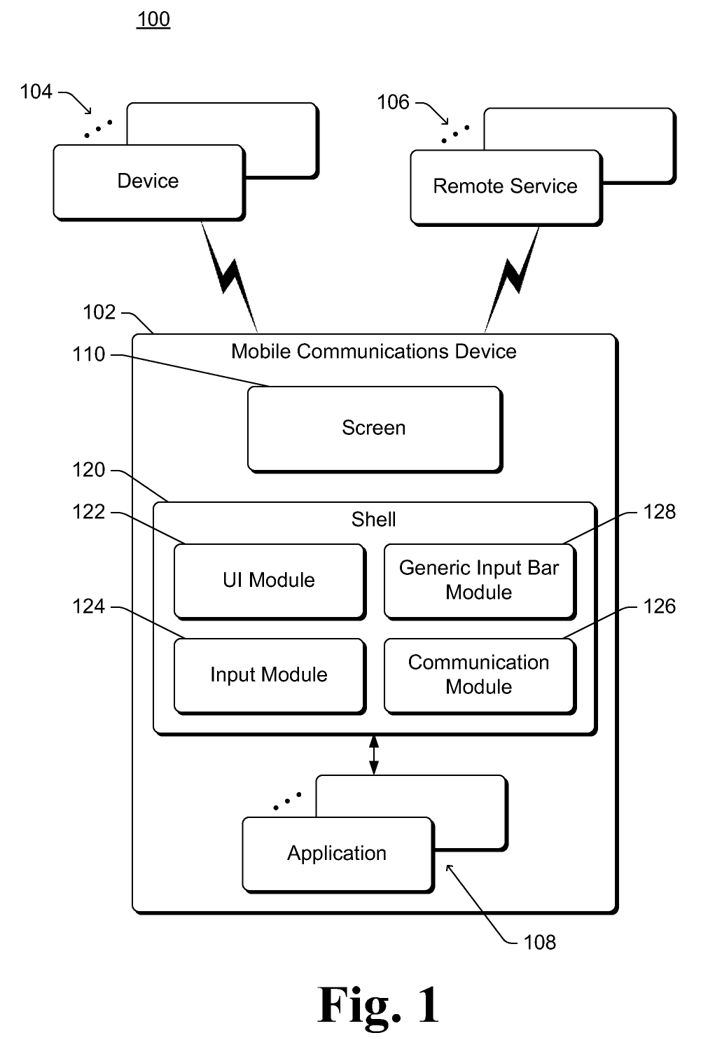

FIG. 1 illustrates an example system 100 implementing the routing user data entries to applications in accordance with one or more embodiments. System 100 includes a mobile communications device 102 that can communicate with one or more other devices 104 and/or one or more remote services 106. A mobile communications device refers to a communications device capable of sending and receiving communications, such as phone calls, text messages, messages including other content types, and so forth. Communications device 102 is referred to as being mobile because it is typically designed to be moved and used in different locations by users. Mobile communications device 102 can be a variety of different types of devices, such as a cellular phone, a satellite phone, other types of wireless phones, a handheld computer, a netbook, a tablet, a personal digital assistant (PDA), an audio and/or video playback device, a portable game device, an automotive computer, a dedicated messaging device, and so forth. It is to be appreciated that mobile communications device 102 can include functionality in addition to being able to send and receive communications calls, such as calendar functionality, audio and/or video playback functionality, mapping functionality, and so forth. It is also to be appreciated that although device 102 is referred to herein as a mobile communications device, device 102 can alternatively be other types of devices.

Devices 104 can be, but need not be, mobile communications devices. Devices 104 can be the same type or alternatively different types of devices as mobile communications device 102.

A remote service 106 is a service implemented physically remotely from mobile communications device 102, such as a social networking service, message routing service, searching service, merchant or marketplace service, and so forth. Each remote service 106 can be implemented on one or more computing devices, such as server computers or other devices analogous to device 102 or devices 104.

Mobile communications device 102 includes one or more applications 108, a screen 110, and a shell module 120. Shell module 120 includes a user interface (UI) module 122, an input module 124, a communication module 126, and a generic input bar module 128. Each of modules 120, 122, 124, 126, and 128 can be implemented in software, firmware, hardware, or combinations thereof. When implemented in software or firmware, such a module includes one or more instructions that are executed by one or more processors or controllers of mobile communications device 102.

Screen 110 is a display component of mobile communications device 102. Screen 110 can be implemented in a variety of different manners, such as using liquid crystal display (LCD) technology, plasma screen technology, image projection technology, and so forth. Alternatively, rather than including screen 110, mobile communications device 102 can generate one or more signals that are output to one or more other display devices which include screen 110.

Shell module 120 includes one or more modules that manage communications, receive user inputs, display images, and so forth as discussed in more detail below. Applications 108 communicate with shell module 120 and provide various functionality. Applications 108 typically rely on shell module 120 to manage receiving of user inputs on behalf of the applications 108, and displaying images generated by applications 108 on screen 110. A variety of different types of applications can be included as applications 108, such as productivity applications (e.g., spreadsheet applications, word processing applications, notepad applications, to-do list applications), recreational applications (e.g., games), resource applications (e.g., databases, digital books), audio/video applications (e.g., digital cameras, digital video cameras, music playback programs), mapping applications, email applications, messaging applications, Internet browsing applications for searching the Internet or navigating to a particular URL (Uniform Resource Locator), and so forth.

Input module 124 receives user inputs from a user of mobile communications device 102. User inputs can be provided in a variety of different manners, such as by pressing a particular portion of a touchpad or touchscreen of device 102, or pressing one or more keys of a keypad or keyboard of device 102. Touchscreen functionality can be provided using a variety of different technologies, such as through capacitive, surface acoustic wave, resistive, optical, strain gauge, dispersive signals, acoustic pulse, or other touchscreen technologies. The user input can also be provided in other manners, such as via audible inputs, other physical feedback input to the device (e.g., tapping any portion of device 102 or another action that can be recognized by a motion detection component of device 102, such as shaking device 102, rotating device 102, etc.), and so forth.

UI module 122 generates, manages, and/or outputs a user interface for display on screen 110. This user interface displays various information on screen 110, and user inputs can be received by input module 124 as discussed above. UI module 122 can display, for example, messages sent by mobile communications device 102 to a device 104 or a service 106, messages received by mobile communications device 102 from devices 104, information received from a service 106, images generated by applications 108, data entry fields or lists generated by generic input bar module 128, and so forth.

Communication module 126 manages receiving of communications from and sending of communications to devices 104. Mobile communications device 102 can communicate with devices 104 using a variety of different technologies and protocols, such as cellular, satellite, and/or other technologies or protocols. The technologies or protocols can include wireless and/or wired technologies and protocols.

Communication module 126 supports a variety of different types of communications with devices 104. One type of communication typically supported by communication module 126 is a voice call. This can include voice calls that are initiated by mobile communications device 102 (e.g., outgoing calls), as well as voice calls that are initiated by another device 104 (e.g., incoming calls). Alternatively, mobile communications device 102 can support other types of communications, and need not support voice calls.

Another type of communication supported by communication module 126 is a message, which refers to text messages or messages with other types of media such as images, video, audio, combinations of types of media, and so forth. In one or more embodiments, messages comply with the Short Message Service (SMS) communication protocol. In one or more other embodiments, messages comply with the Multimedia Messaging Service (MMS) communication protocol. It is to be appreciated that SMS and MMS are only example protocols, and that other communication protocols can alternatively be used. Various other types of communications can also be supported by communication module 126, such as mobile instant messaging (mobile IM), email (electronic mail), and so forth.

In one or more embodiments, communication module 126 also manages communication with services 106. This communication can be performed using a variety of different networks, including the Internet, a local area network (LAN), a public telephone network, an intranet, a cellular or other wireless phone network, other public and/or proprietary networks, combinations thereof, and so forth. Communication module 126 can obtain data from and/or send data to a service 106 using a variety of different technologies and protocols as discussed above.

Generic input bar module 128 generates an input bar for display (or other presentation) via UI module 122. The input bar is a data input field in which data input by the user of mobile communications device 102 via input module 124 is displayed. A variety of different data can be input by the user, such as text, symbols, drawings, and so forth. Generic input bar module 128 can also communicate with a camera or other image capture device to allow the user to capture a photo or video as the data input by the user. In response to a user input via module 124 requesting to capture a photo or video, an indication of the captured photo or video is displayed in the input bar (e.g., a text description of the captured photo or video, a thumbnail of the captured photo or video, the captured photo, etc.). The input bar is referred to as generic because it is used for input to multiple different applications 108, and the user can input data without having to first launch or otherwise identify the application 108 to which the data is intended to be provided.

In one or more embodiments, the generic input bar is displayed on screen 110 for easy and quick accessibility by the user of device 102. For example, the generic input bar can be displayed on a home page or home screen displayed by shell 120, in a header or toolbar portion displayed by shell 120, and so forth. The generic input bar can be displayed constantly, or alternatively in response to a user request to display the generic input bar. For example, a shortcut key or key sequence, or other user input received via input module 124, can be used to cause module 128 to display the generic input bar on screen 110.

With the generic input bar displayed, the user of mobile communications device 102 can input data via input module 124. This data input by the user can be text, symbols, drawings, a captured video, a captured photo, and so forth. When the user has completed inputting the data he or she desires, the user indicates an end to the data input. The data that the user has input is also referred to as a user data entry. The user can indicate the end of the data input in a variety of different manners, such as by selecting an “end” or “return” key or button, by inputting another key or input sequence indicating the end of the data input, by selecting an application to which the data is to be routed, and so forth. Alternatively, rather than the user indicating the end of the data input, a module of shell 120 can automatically identify the end of the data input. For example, the end of the data input can be automatically detected after a threshold amount of time has elapsed without any user input being received by input module 124.

A variety of different types of data can be input by the user via the generic input bar. For example, a user can enter a phone number, a person's name, the name of a restaurant or merchant, a note to remind himself or herself to do something, a drawing, and so forth.

Once input, the user of device 102 can select one or more applications 108 to which the user data entry is to be routed. Routing the user data entry to an application 108 refers to providing the user data entry to the application 108. The manner in which the application 108 uses a particular user data entry can vary based on the particular application 108 and/or the user data entry. For example, the application 108 may place a phone call to a phone number in the user data entry, generate a new contact using the data in the user data entry, add the user data entry to a calendar item, add the user data entry to a photo album, and so forth.

The user can select one or more applications 108 to which the user data entry is to be routed in a variety of different manners. In one or more embodiments, generic input bar module 128 displays, along with the user data entry, a button or other icon representing each application 108 to which the user data entry could be routed. The user can then select, via an input received by input module 124, one of these displayed buttons or icons. In other embodiments, the user can select an application 108 via other UI mechanisms, such as a pull-down menu, buttons or keys on a keypad, and so forth.

In addition to routing user data entries to an application 108 on mobile communications device 102, the user data entries can also be routed to a remote service 106 (e.g., to an application running on a remote service 106). Thus, a user of device 102 can select, for example, to have a user data entry routed to both an application 108 on device 102 and to a remote service 106.

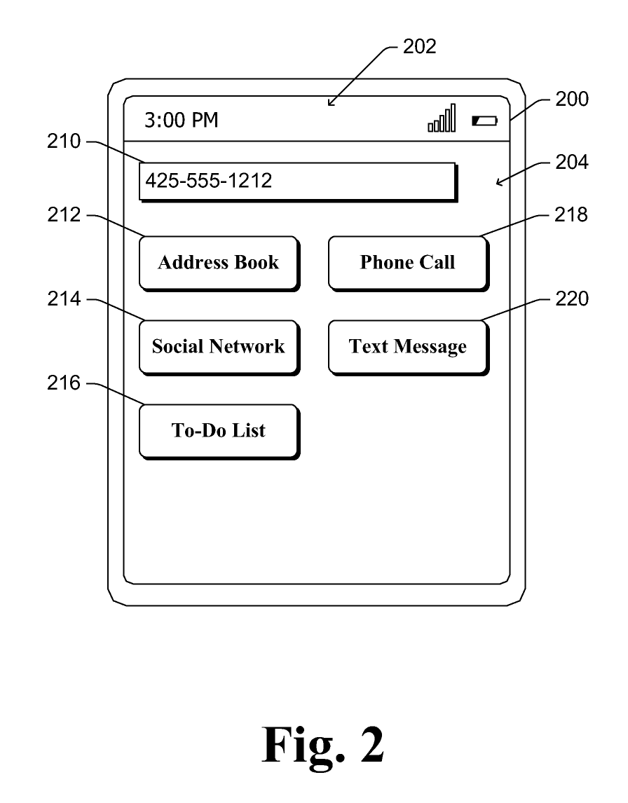

FIG. 2 is a diagram illustrating an example screen display of a mobile communications device in accordance with one or more embodiments. In FIG. 2, a screen 200 is displayed having a header portion 202 and an application display portion 204. Generally, images generated by an application running on the mobile communications device are displayed in application display portion 204, while information describing those applications and/or the operation of the mobile communications device is displayed in header portion 202. For example, header portion 202 can include a current time, one or more vertical bars indicating the strength of a wireless signal being received by the mobile communications device, a battery charge indicator, and so forth. It is to be appreciated, however, that different and/or additional information can be displayed in header portion 202.

A generic input bar 210 is displayed in portion 204, as well as multiple buttons 212, 214, 216, 218, and 220. In the example of FIG. 2, the user has entered data of “425-555-1212” into bar 210. The user can then select one or more of buttons 212-220 to route the user data entry (which is “425-555-1212” in the illustrated example) to one or more applications identified by the selected buttons. For example, the user can select button 212 to have the user data entry routed to an address book application (e.g., and added as a contact in the address book), button 214 to have the user data entry routed to a social networking service (e.g., and added to his or her social networking page), button 216 to have the user data entry routed to a list or notepad application (e.g., and added to his or her to-do list), button 218 to have the user data entry routed to a phone application (e.g., and have a phone call placed to the phone number that is the user data entry), and/or button 220 to have the user data entry routed to a text messaging application (e.g., and have text message sent to the phone number that is the user data entry).

Although FIG. 2 is illustrated with buttons 212-220, it is to be appreciated that the applications to which the user data entry can be routed can be identified for user selection in other manners.

Returning to FIG. 1, in one or more embodiments, input bar module 128 maintains a list of user data entries that have been input via the generic input bar. Each new user data entry that is input by the user is added to the list by module 128. This list can then be displayed (e.g., in response to a user request to display the list received via input module 124) on screen 110. This list can include the user data entries and/or indications of the user data entries (e.g., descriptions or thumbnails of captured photos or video). The user is able to select a user data entry from the list, select one of applications 108, and in response to these selections have the selected user data entry routed to the selected application. The user is able to select a user data entry from the list by, for example, touching the entry with his or her finger or a stylus, or other input via module 124.

It should be noted that after routing of a user data entry from the list to an application, the user data entry remains on the list. Thus, the user data entry can be routed to multiple additional applications or services selected by the user. Additionally, while a particular user data entry is in the list a user can return to that particular user data entry and modify or edit that entry (e.g., to add additional data to the entry, to correct a mistake or typographical error, and so forth). The user can thus correct an error in a particular user data entry and then route that particular user data entry to one or more applications or services.

User data entries can be removed from the list of user data entries in a variety of different manners. In one or more embodiments, user data entries remain on the list of user data entries until a user requests that an entry be deleted (e.g., by selecting the entry and a delete button or key). Alternatively, a limit can optionally be imposed on the size of the list of user data entries, and user data entries can be deleted (optionally after receiving user approval to do so) when this limit is met. The user data entry or entries that are deleted when this limit is met can be identified in different manners, such as being the oldest (least recently input) user data input, the least recently routed user data input, the most frequently routed user data input, and so forth.

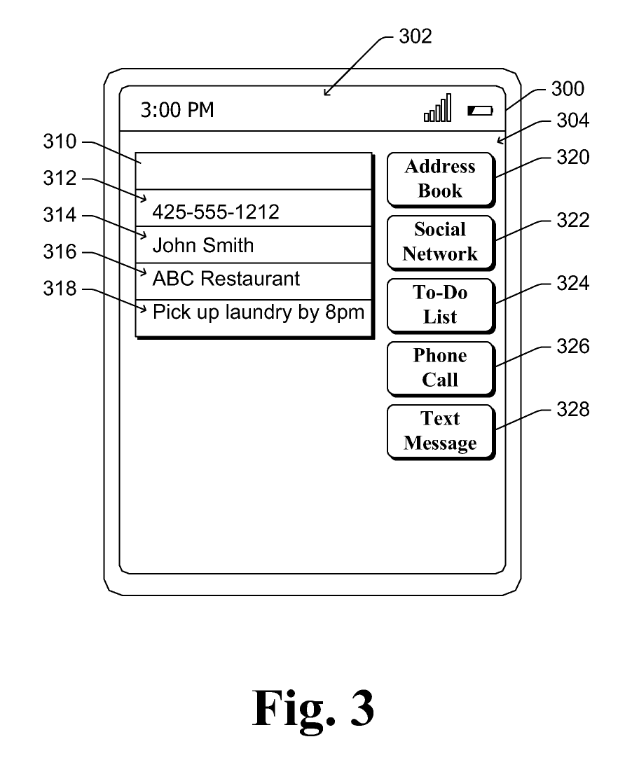

FIG. 3 is a diagram illustrating another example screen display of a mobile communications device in accordance with one or more embodiments. In FIG. 3, a screen 300 is displayed having a header portion 302 and an application display portion 304, analogous to header portion 202 and application display portion 204, respectively, of FIG. 2.

A generic input bar 310 is displayed in portion 304, analogous to generic input bar 210 of FIG. 2. However, the user has not yet begun inputting a current user data entry into bar 310. Below generic input bar 310 is a list of user data entries 312, 314, 316, and 318. This list of user data entries are user data entries previously input by the user to generic input bar 310. The user data entries 312, 314, 316, and 318 can be displayed in accordance with a variety of different ordering techniques or rules, such as ordering user data entries according to how recently they were input by the user, alphabetically, based on how recently they were selected by the user for routing to an application, and so forth. The list of user data entries is illustrated in FIG. 3 as including four user data entries, although alternatively the list of user data entries can include a greater or smaller number of user date entries.

Multiple buttons 320, 322, 324, 326, and 328 are also included in display portion 304. The user can select a user data entry from the list of user data entries, and also select one or more of buttons 320-328 to route the selected user data entry to one or more applications identified by the selected buttons. For example, the user can select button 320 to have the user data entry routed to an address book application (e.g., and added as a contact in the address book), button 322 to have the user data entry routed to a social networking service (e.g., and published to his or her friends on the social networking service), button 324 to have the user data entry routed to a list or notepad application (e.g., and added to his or her to-do list), button 326 to have the user data entry routed to a phone application (e.g., and have a phone call placed to the phone number that is the user data entry), or button 328 to have the user data entry routed to a text messaging application (e.g., and have text message sent to the phone number that is the user data entry).

Thus, the user can input multiple user data entries into generic input bar 310, have those user data entries displayed as a list, and then select from the list of user data entries. The user can also select one or more applications to which a particular user data entry is to be routed even after entering subsequent user data entries.

Although FIG. 3 is illustrated with buttons 320-328, it is to be appreciated that the applications to which the user data entry can be routed can be identified for user selection in other manners.

Returning to FIG. 1, a user data entry can be routed to one or more applications 108 and/or remote services 106 as discussed above. Generic input bar module 128 can route, via communication module 126, user data entries to an application 108 or remote service 106 in a variety of different manners. In one or more embodiments, each application 108 and remote service 106 registers with generic input bar module 128. As part of this registration process, the application 108 or service 106 provides module 128 with information identifying how to route data to the application 108 or service 106. Module 128 (or alternatively another module, such as communication module 126) maintains a record of this information, and uses the maintained information to route the user data entry to the application 108 or service 106 when selected by the user of device 102. Additionally, as part of this registration process the application 108 or service 106 can notify generic input bar module 128 of a particular button or icon to use to display the application 108 or service 106 for selection (e.g., as a button 212-220 of FIG. 2 or button 320-328 of FIG. 3).

Alternatively, generic input bar module 128 can route user data entries to an application 108 or remote service 106 in different manners. For example, an application 108 or service 106 can expose an application programming interface (API) to module 128. Module 128 can be configured or programmed with knowledge of the API or otherwise discover the API in a variety of different manners. Module 128 can then invoke this API to route user data entries to the application 108 or service 106. By way of another example, module 128 can communicate with application 108 and service 106 according to a protocol that is programmed into or otherwise known by module 128, application 108, service 106. Module 128 can route user data entries to the application 108 or service 106 using this known protocol.

The action taken by an application 108 or remote service 106 upon receipt of a user data entry can vary. In one or more embodiments, each application 108 and service 106 has a default behavior that it performs with a received user data entry (e.g., adds the entry to a note document, adds the entry to a new contact, adds the entry to a list, initiates a phone call based on the entry, and so forth). This default behavior can optionally be changed by a user of device 102. For example, the application 108 or service 106 can present a configuration display (e.g., via UI module 122) identifying different default operations that can be performed with a user data entry and allowing the user to select from those different default operations. A record of the default operation selected by the user can then be maintained by the application 108 or service 106 (or generic input bar module 128), and the selected default operation used for user data entries subsequently received by the application 108 or service 106.

In other embodiments, different behaviors can be performed by an application 108 or service 106 based on a user selection. Different buttons or menu items can be selected for different behaviors to be performed by an application 108 or service 106. An identifier of the part behavior to be performed can be routed to the application 108 or service 106 in a variety of different manners, analogous to the routing of the user data entry as discussed above. For example, an Internet browsing application can have two buttons displayed from which the user can select, one button associated with Internet searching and the other button associated with Internet navigation. If the button associated with Internet searching is selected, then the user data entry is routed to an Internet browsing application, which in turn accesses a search engine or service to search for web pages having the user data entry. However, if the button associated with Internet navigation is selected, then the user data entry is routed to the Internet browsing application, which in turn treats the user data entry as a URL and navigates to the web page having a URL of the user data entry. Other behaviors could also be performed by the Internet browsing application, such as creating a bookmark or favorites entry that includes the user data entry.

In still other embodiments, different behaviors can be performed by an application 108 or service 106 based on the particular user data entry. The application 108 or service 106 analyzes the user data entry and automatically identifies the user data entry as a particular type of entry (e.g., a phone number, a text messaging address, a URL, and so forth). This automatic identification can be performed in a variety of different manners, such as based on the particular format of the user data entry (e.g., a user data entry be automatically identified as a URL if it begins with “www.” and includes no spaces, a user data entry can be automatically identified as a phone number if it includes 7 or 10 numeric digits and includes no letters, and so forth).

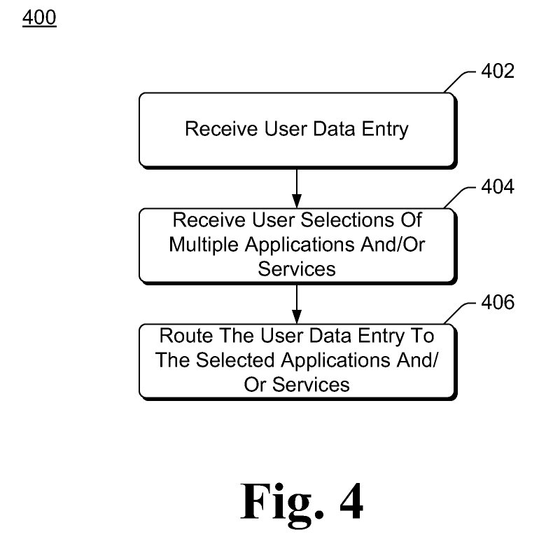

FIG. 4 is a flowchart illustrating an example process 400 for a device routing user data entries to applications in accordance with one or more embodiments. Process 400 is carried out by a device, such as mobile communications device 102 of FIG. 1, and can be implemented in software, firmware, hardware, or combinations thereof. Process 400 is shown as a set of acts and is not limited to the order shown for performing the operations of the various acts. Process 400 is an example process for routing user data entries to applications; additional discussions of routing user data entries to applications are included herein with reference to different figures.

In process 400, a user data entry is received (act 402). The user data entry is received via a generic input bar and can be received in a variety of different manners as discussed above. As discussed above, this user data entry can be text, symbols, drawings, a captured video, a captured photo, and so forth.

User selections of multiple applications and/or services are received (act 404). These multiple applications and/or services include applications that are included on the device implementing process 400 and/or remote services as discussed above.

The user data entry received in act 402 is routed to the selected applications and/or services (act 406). The manner in which the user data entry is routed to the selected applications and/or services can be identified in different manners as discussed above.

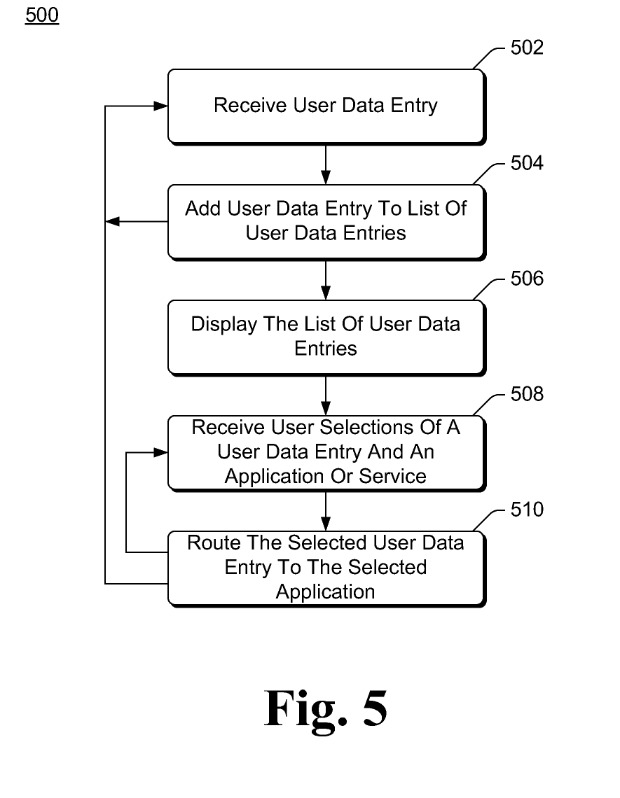

FIG. 5 is a flowchart illustrating an example process 500 for a device routing user data entries to applications in accordance with one or more embodiments. Process 500 is carried out by a device, such as mobile communications device 102 of FIG. 1, and can be implemented in software, firmware, hardware, or combinations thereof. Process 500 is shown as a set of acts and is not limited to the order shown for performing the operations of the various acts. Process 500 is an example process for routing user data entries to applications; additional discussions of routing user data entries to applications are included herein with reference to different figures.

In process 500, a user data entry is received (act 502). The user data entry is received via a generic input bar and can be received in a variety of different manners as discussed above. As discussed above, this user data entry can be text, symbols, drawings, a captured video, a captured photo, and so forth.

The received user data entry is added to a list of user data entries (act 504). Acts 502 and 504 can be repeated multiple times, with each new user data entry being added to the list of user data entries.

Additionally, the list of user data entries is displayed or otherwise presented to a user of the device implementing process 500 (act 506). The list of user data entries can be displayed in response to a user request to display the list, or alternatively can be displayed automatically in response to some other event or action (e.g., in response to a user request to display the generic input bar).

User selections of a user data entry and an application (or service) are received (act 508). These user selections can be received in a variety of different manners as discussed above.

The user data entry selected in act 508 is routed to the application or service selected in act 508 (act 510). The manner in which the selected user data entry is to be routed to the selected application or service can be identified in different manners as discussed above.

Acts 508 and 510 can be repeated multiple times, with the user selecting different user data entries and/or applications (or services) each time. Additionally, process 500 can return to receive additional user data entries and add those additional user data entries to the list of user data entries in acts 502 and 504. These additional user data entries can then be displayed in act 506 and selected in act 508.

The routing user data entries to applications allows for a variety of different usage scenarios. Generally, the user can quickly input his or her desired data while it is fresh in his or her mind (e.g., he or she is thinking of a particular phone number, a particular person's name, the name of a particular restaurant, etc.). The user can then instruct the mobile communications device what to do with the desired data after he or she has input the data into the generic input bar.

Following are several examples of usage scenarios for the routing user data entries to applications. It is to be appreciated that these are examples, and that various other usage scenarios are also supported by the routing user data entries to applications. One example usage scenario is the user entering a phone number into the generic input bar, then selecting to route the phone number to a first application to create a contact with the phone number, and to a second application to initiate a voice call or text message to the phone number. Another example usage scenario is the user entering a quote into the generic input bar, then selecting to route the quote to a first application to search for the author of the quote, to a second application to text the quote to one or more friends, and to a social networking service to display the quote. Yet another example usage scenario is the user capturing a photo via a camera of the device, then selecting to route the photo to a first application to add to a photo album on the device, to a second application to initiate an image (e.g., SMS) message with the photo to send to a friend, and to a social networking service to display the photo.

Another example usage scenario is the user entering the name of an artist that was recommended to the user into the generic input bar, then selecting to route the artist name to a music marketplace service to search for and purchase an album by the artist, to a search engine to search the Internet and learn more about the artist, and to another service to share the name of the artist via a social networking service or message routing service. Yet another example usage scenario is the user entering the name of a restaurant that he or she wants to try into the generic input bar, then selecting to route the restaurant name to a reviewing application or service to read more about the restaurant, to a calendar application to schedule a date and time to go to the restaurant, and to a to-do list application to add a to-do list item to make a reservation or invite a friend. Still another example usage scenario is the user entering an idea into the generic input bar, then selecting to route the idea to a first application to email the idea to himself or herself (and/or to others), and to a notepad application to save the idea in a note.

Another example usage scenario is the user entering a URL of a web page, then selecting to route the URL to an Internet browsing application to have the web page displayed to the user. This URL is maintained in the list of user data entries so that the user can go back through the list and route the URL to the Internet browsing application at a later time (and do so repeatedly). The user can also select to route the URL to another application or service, such as to a social networking service to publish the URL to his or her friends, and to an application to send a text message that includes the URL to a friend. Yet another example usage scenario is the user entering a search term, then selecting to route the search term to an Internet browsing application to search for the search term. This search term is maintained in the list of user data entries so that the user has a list of his or her search terms (his or her search history), and can route a search term to the Internet browsing application at a later time (and do so repeatedly). The user can also select to route the search term to another application or service, such as to a social networking service to publish the search term to his or her friends, and to an application to send a text message that includes the search term to a friend.

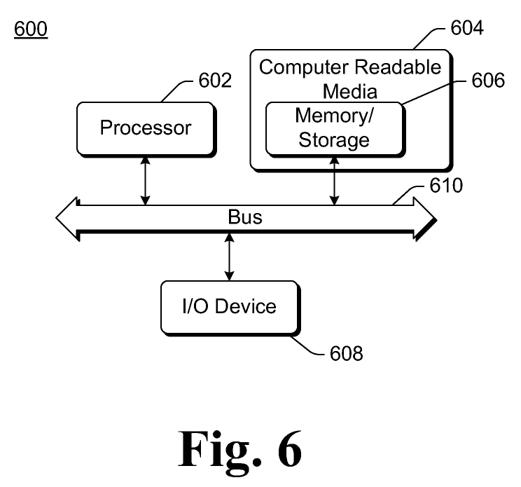

FIG. 6 illustrates an example computing device 600 that can be configured to implement the routing user data entries to applications in accordance with one or more embodiments. Computing device 600 can be, for example, device 102 or a device 104 of FIG. 1, or can implement at least part of a remote service 106.

Computing device 600 includes one or more processors or processing units 602, one or more computer readable media 604 which can include one or more memory and/or storage components 606, one or more input/output (I/O) devices 608, and a bus 610 that allows the various components and devices to communicate with one another. Computer readable media 604 and/or one or more I/O devices 608 can be included as part of, or alternatively may be coupled to, computing device 600. Bus 610 represents one or more of several types of bus structures, including a memory bus or memory controller, a peripheral bus, an accelerated graphics port, a processor or local bus, and so forth using a variety of different bus architectures. Bus 610 can include wired and/or wireless buses.

Memory/storage component 606 represents one or more computer storage media. Component 606 can include volatile media (such as random access memory (RAM)) and/or nonvolatile media (such as read only memory (ROM), Flash memory, optical disks, magnetic disks, and so forth). Component 606 can include fixed media (e.g., RAM, ROM, a fixed hard drive, etc.) as well as removable media (e.g., a Flash memory drive, a removable hard drive, an optical disk, and so forth).

The techniques discussed herein can be implemented in software, with instructions being executed by one or more processing units 602. It is to be appreciated that different instructions can be stored in different components of computing device 600, such as in a processing unit 602, in various cache memories of a processing unit 602, in other cache memories of device 600 (not shown), on other computer readable media, and so forth. Additionally, it is to be appreciated that the location where instructions are stored in computing device 600 can change over time.

One or more input/output devices 608 allow a user to enter commands and information to computing device 600, and also allows information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embody computer readable instructions, data structures, program modules, or other data in a modulated data signal, such as carrier wave or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above are also included within the scope of computer readable media.

Generally, any of the functions or techniques described herein can be implemented using software, firmware, hardware (e.g., fixed logic circuitry), manual processing, or a combination of these implementations. The terms “module” and “component” as used herein generally represent software, firmware, hardware, or combinations thereof. In the case of a software implementation, the module or component represents program code that performs specified tasks when executed on a processor (e.g., CPU or CPUs). The program code can be stored in one or more computer readable memory devices, further description of which may be found with reference to FIG. 6. The features of the routing user data entries to applications techniques described herein are platform-independent, meaning that the techniques can be implemented on a variety of commercial computing platforms having a variety of processors.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
receiving, at a mobile communications device, a first user data entry;
receiving, after receiving the first user data entry, a user selection of a first application of multiple applications;
receiving, after receiving the first user data entry, a user selection of a second application of the multiple applications;
routing, in response to the user selection of the first application, the first user data entry to the first application; and
routing, in response to the user selection of the second application, the first user data entry to the second application.

2. A method as recited in claim 1, wherein the second application is running on a remote service.

3. A method as recited in claim 2, wherein the remote service comprises a social networking service.

4. A method as recited in claim 2, wherein the remote service comprises a message routing service.

5. A method as recited in claim 1, further comprising:
receiving multiple additional user data entries; and
wherein receiving the user selection of the first application comprises receiving the user selection of the first application after receiving the multiple additional user data entries.

6. A method as recited in claim 1, wherein the first user data entry comprises a text entry.

7. A method as recited in claim 1, wherein the first user data entry comprises a captured photo.

8. A method as recited in claim 1, further comprising:
receiving, after routing the first user data entry to both the first application and the second application, a user selection of a third application of the multiple applications; and
routing, in response to the user selection of the third application, the first user data entry to the third application.

9. A method as recited in claim 1, further comprising:
receiving multiple additional user data entries;
adding each of the first user data entry and the multiple additional user data entries to a list of user data entries;
displaying the list of user data entries;
receiving a user selection of a user data entry displayed in the list of user data entries;
receiving a user selection of a third application of the multiple applications; and
routing the user-selected user data entry to the third application.

10. A method as recited in claim 9, further comprising keeping the user-selected user data entry in the list after routing the user-selected user data entry to the third application.

11. A method as recited in claim 1, wherein the first user data entry comprises a phone number, wherein the first application is to initiate a phone call to the phone number, and wherein the second application is to create an address book contact with the phone number.

12. A method as recited in claim 1, further comprising receiving, from each of the first application and the second application, information identifying how to route the first user data entry to the application.

13. A computing device comprising:
a user interface module to display a data input bar;
an input module to receive a first user data entry into the data input bar, to subsequently receive a second user data entry into the data input bar, and to subsequently receive a user selection of a first application to which the first user data entry is to be routed; and
a generic input bar module to receive from the input module both the first user data entry and the second user data entry, to maintain a list of user data entries including both the first user data entry and the second user data entry, to provide the list to the user interface module for display, to receive the user selection of the first user data entry from the displayed list of user data entries, and to route the first user data entry to the first application in response to the user selection of the first data entry from the displayed list of user data entries and to the user selection of the first application.

14. A computing device as recited in claim 13, wherein the first application is running on a remote service.

15. A computing device as recited in claim 14, wherein the remote service comprises a social networking service.

16. A computing device as recited in claim 13, wherein the user interface module is further to display multiple buttons each associated with one of multiple applications, and wherein the user selects the first application by selecting one of the multiple buttons associated with the first application.

17. A computing device as recited in claim 13, wherein the generic input bar module is further configured to receive a user selection of a second application to which the first user data entry is to be routed, and to route the first user data entry to the second application in response to the user selection of the first data entry from the displayed list of user data entries and to the user selection of the second application.

18. A computing device as recited in claim 17, wherein the first application is running on a remote service and the second application is running on the computing device.

19. A computing device as recited in claim 13, wherein the generic input bar module is further to keep both the first user data entry and the second user data entry in the list of user data entries after routing the first user data entry to the first application.

20. One or more computer storage media having stored thereon multiple instructions that, when executed by one or more processors of a mobile communications device, cause the one or more processors to:
receive a first user data entry;
receive, after receiving the first user data entry, a second user data entry;
add both the first user data entry and the second user data entry to a list of data entries;
display the list of data entries;
receive, after receiving both the first user data entry and the second user data entry, both a first user selection of the first user data entry from the list of data entries and a user selection of a first application of multiple applications;
route, in response to the first user selection of the first user data entry and the user selection of the first application, the first user data entry to the first application;
receive, after receiving both the first user selection of the first user data entry and the user selection of the first application, both a second user selection of the first user data entry from the list of data entries and a user selection of a second application of the multiple applications; and
route, in response to the second user selection of the first user data entry and the user selection of the second application, the first user data entry to the second application.
